(19) United States
(12) Patent Application Publication
(10) Pub. No.: US 2011/0279065 A1
(43) Pub. Date: Nov. 17, 2011

(54) MERCURY-FREE MOLECULAR DISCHARGE LAMP

(75) Inventors: Rainer Hilbig, Aachen (DE); Achim Gerhard Rolf Koerber, Kerkrade (NL); Stefan Schwan, Herzogenrath (DE); Daiyu Hayashi, Aachen (DE)

(73) Assignee: KONINKLIJKE PHILIPS ELECTRONICS N.V., EINDHOVEN (NL)

(21) Appl. No.: 13/143,595

(22) PCT Filed: Jan. 7, 2010
(86) PCT No.: PCT/IB2010/050040

§ 371 Date: Jul. 7, 2011

(30) Foreign Application Priority Data
Jan. 9, 2009 (EP) 09150265.8

(51) Int. Cl. H01J 61/00

(52) U.S. Cl. 315/363

(57) ABSTRACT

The invention relates to a mercury-free molecular discharge lamp (30), which comprises: a light-transmitting discharge vessel (32) enclosing, in a gastight manner, a discharge space comprising a gas filling (34). The mercury-free molecular discharge lamp further comprises discharge means (36) for maintaining a discharge (38) in the discharge space, and discharge-variation means (40, 42) for varying, in operation, a position of the discharge within the gas filling relative to each other, and/or for varying a dimension of the discharge within the gas filling over time. An effect of the varying of the position and/or dimension of the discharge over time is that at a specific variation-speed or variation-frequency the output power and/or luminous flux of the mercury-free molecular discharge lamp is substantially increased. This effect is found to be depending on the gas filling and on the variation-speed and/or variation-frequency.

### FIELD OF THE INVENTION

The invention relates to a mercury-free molecular discharge lamp.

### BACKGROUND OF THE INVENTION

Low-pressure gas discharge lamps often comprise mercury as a primary component for the generation of ultraviolet (further also referred to as UV) light. A luminescent layer comprising a luminescent material may be present on an inner wall of a discharge vessel to convert UV light from the mercury into light of increased wavelength, for example, UV-C for medical purposes, UV-B and UV-A for tanning purposes (sun tanning lamps) or visible radiation for general illumination purposes. Such discharge lamps are therefore also referred to as fluorescent lamps.

The discharge vessel of low-pressure mercury vapor discharge lamps is usually constituted by a light-transmitting envelope enclosing a discharge space in a gastight manner. The discharge vessel is generally circular and comprises both elongate and compact embodiments.

Novel developments in low-pressure discharge lamps led to the introduction of so-called molecular discharge lamps which at least partially emit visible light. These molecular discharge lamps comprise a metal compound together with, for example, halogens. The light emitted from the discharge space comprises, in addition to the characteristic lines of the metal, also a contribution from different compounds of the metal, such as chlorides, bromides, iodides and/or, for example, oxy-iodides, which are present in the discharge space. These different compounds of the metal typically emit visible light which does not need to be converted via a luminescent layer. Therefore, the efficiency of molecular discharge lamps is generally higher than that of non-molecular discharge lamps. Such a molecular discharge lamp is, for example, known from WO 2007/132368.

A drawback of these known molecular discharge lamps is that the efficiency and/or efficacy still are not optimal.

### SUMMARY OF THE INVENTION

It is an object of the invention to provide a molecular gas discharge lamp with improved efficiency and/or efficacy.

According to a first aspect of the invention, the object is achieved with a mercury-free molecular discharge lamp, comprising:

a light-transmitting discharge vessel enclosing, in a gastight manner, a discharge space comprising a gas filling,

discharge means for maintaining a discharge in the discharge space, and

discharge-variation means for varying, in operation, the position of the discharge within the gas filling relative to each other, and/or for varying a dimension of the discharge within the gas filling over time for increasing the output power and/or luminous flux of the mercury-free molecular discharge lamp.

The varying of the position of the discharge within the gas filling relative to each other involves embodiments in which the position of the discharge is varied within the gas filling, in which the position of the gas filling in which the discharge is present is varied relative to the discharge, and in which both the position of the gas filling and the discharge are varied and in which there is a difference of the speed or direction of the variation of the position of the gas filling and discharge with respect to each other.

Not wishing to be held to any particular theory, the inventors have found that the efficiency of the molecular discharge in the mercury-free molecular discharge lamp improves when the position of the discharge within the gas filling is varied. As indicated before, molecular discharge lamps generally emit light within the visible range, thus omitting the need for luminescent material which is typically used to convert ultraviolet radiation into visible light. Therefore, the efficiency of the molecular discharge lamps is already improved compared to known low-pressure discharge lamps. In experiments with mercury-free molecular discharge lamps, the inventors have found that by varying the position and/or the dimension of the discharge, in operation, within the gas filling, an increase of the emission intensity of molecular discharge lamps is registered. It has been found that this increase of the emission intensity comprises an optimum variation-speed or optimum variation-frequency of the discharge within the gas filling. Furthermore, these experiments have shown that the maximum emission intensity at the optimum variation-speed or optimum variation-frequency is reached relatively slowly: it may take more than 10 minutes of operation of the mercury-free molecular discharge lamp at the optimum variation-speed or variation-frequency before the maximum emission intensity is reached. Maximum emission intensities of up to approximately twice the emission intensity at values away from the optimum variation-speed or variation-frequency are observed. On the other hand, the experiments have revealed that a relatively quick reduction of the emission intensity is registered upon altering the variation speed or frequency to values away from the optimum variation speed or frequency: the reduction of the intensity may take place after several seconds of operation of the mercury-free molecular discharge lamp at values away from the optimum variation-speed and/or variation-frequency. Although the physical process behind this improved efficiency of mercury-free molecular discharge lamps at the optimum variation-speed and/or variation-frequency is not completely understood, the inventors have ruled out mixing effects of different components in the gas filling because of the differences in time required for reaching the maximum emission intensity after application of the optimum variation-speed compared to the time required for reducing the emission intensity when the mercury-free molecular discharge lamp is operated at values away from the optimum variation-speed or variation-frequency.

The molecular discharge lamp according to the invention is a mercury-free molecular discharge lamp. The presence of mercury in the discharge would generate a relatively large amount of ultraviolet radiation. As the radiation generated by the molecular discharge lamp is preferably visible light, the presence of ultraviolet radiation is not preferred. Furthermore, part of the emission spectrum of mercury comprises emission in the violet/blue color range. If mercury were to be present in the discharge, a relatively strong contribution of blue or violet would be present in the emission spectrum of the molecular discharge lamp due to the mercury and no contribution of the mercury would be present in the red region of the spectrum This would generate a lamp having a blue-ish emission color, which again is generally not preferred. Finally, when mercury is present in the discharge, the discharge temperature and the voltage required for generating and/or maintaining the discharge in the discharge lamp are both higher compared to molecular discharge lamps without mercury. Such higher discharge temperature and/or voltage require more power for generating and/or maintaining the discharge in the molecular discharge lamp, which would reduce the efficiency of the molecular discharge lamp. Therefore, molecular discharge lamps are generally mercury-free molecular discharge lamps.

In an embodiment of the mercury-free molecular discharge lamp, the discharge-variation means are configured for varying the position and/or dimension of the discharge within the gas filling continuously and/or periodically. An advantage of this embodiment is that it enables changing the color-point of the light emitted from the mercury-free molecular discharge lamp without having to alter the gas filling. By switching the discharge-variation means on or off, the spectrum of the light emitted by the mercury-free molecular discharge lamp may be changed, thus altering the color of the emitted light.

In an embodiment of the mercury-free molecular discharge lamp, the discharge-variation means are configured for varying the position and/or dimension at an optimum variation-speed and/or variation-frequency, the optimum variation-speed and/or variation-frequency depending on the gas filling of the discharge space. The inventors have found that the optimum variation-speed and/or variation-frequency strongly depend on the gas filling of the discharge lamp. Experiments have shown that, using the same discharge vessel, the same discharge means, and the same discharge-variation means, different gas fillings require different optimum variation-speeds and/or variation-frequencies. When, for example, the position of the discharge within the gas filling is varied by rotating the discharge vessel at an optimum rotation frequency, a first gas filling comprising ZrBr₄ and P₂O₅ has an optimum rotation frequency of 18 Hertz, while a second gas filling comprising HfBr₄ with Sulfur has an optimum rotation frequency of 1.5 Hertz. Varying the position and/or dimension at this optimum variation-speed and/or variation-frequency will increase the output power of the mercury-free molecular discharge lamp considerably. Considerably means that an improvement of up to a factor 2 has been registered.

In an embodiment of the mercury-free molecular discharge lamp, the discharge-variation means comprise: rotating means for rotating the discharge and the gas filling relative to each other for varying the position and/or dimension of the discharge. An advantage of this embodiment is that the invented optimization of the plasma emission can be used without any interaction with the originally used operating conditions such as lamp power, dc-operation, etc.

In an alternative embodiment, the discharge-variation means comprise: pulse-generation means for applying a power to the mercury-free molecular discharge lamp in a pulsed-mode for varying the position and/or dimension of the discharge. An advantage of this embodiment is that it may be incorporated relatively easily by adapting the power supply of the mercury-free molecular discharge lamp by providing the power in a pulsed-mode operation. At a specific pulsed-mode frequency, the plasma may encounter instabilities which may lead to movement of the plasma within the discharge vessel and thus within the gas filling. During such specific pulsed-mode frequency, the output power of the mercury-free molecular discharge lamp increases gradually towards a maximum output power. When moving away from the specific pulsed-mode frequency, the increased output power relatively quickly diminishes and the output power of the mercury-free molecular discharge lamp returns to its original output power.

In an alternative embodiment, the discharge-variation means comprise: amplitude-modulation means for applying power to the mercury-free molecular discharge lamp in an amplitude-modulation mode for varying the position and/or dimension of the discharge. Again, this amplitude-modulation mode may be relatively easy to incorporate by adapting the power supply of the mercury-free molecular discharge lamp.

In an alternative embodiment, the discharge-variation means comprise: frequency-modulation means for applying power to the mercury-free molecular discharge lamp in a frequency-modulation mode for varying the position and/or dimension of the discharge. Also this frequency-modulation mode may be relatively easy to incorporate by adapting the power supply of the mercury-free molecular discharge lamp. A further advantage of the use of frequency-modulation means is that the mercury-free molecular discharge lamp may generate less Electro-Magnetic Interference due to interference, if any, being spread over the larger frequency band.

In an embodiment of the mercury-free molecular discharge lamp comprising rotating means as the discharge-variation means, the rotating means are configured for rotating the discharge vessel. An advantage of this embodiment is that rotating discharge vessels are already in use, for example, for avoiding hot-spots on the discharge vessel of electrodeless discharge lamps or for mixing mercury in some mercury vapor discharge lamps such as shown, for example, in U.S. Pat. No. 4,954,756. Re-using such a discharge vessel may be relatively easy, but here this relates to a mercury-free molecular discharge lamp in which the rotation frequency of the discharge vessel is preferably tuned to an optimum rotation speed at which the output power of the mercury-free molecular discharge lamp increases. When reading U.S. Pat. No. 4,954,756, the skilled person learns that the reason for rotating the discharge vessel is to improve the mixing of mercury in the discharge mixture of U.S. Pat. No. 4,954,756 and that the speed of rotation of the discharge vessel should be above a certain minimum level to ensure that the mixing is sufficient. Therefore, when rotating a mercury-free molecular discharge lamp, using such a rotating discharge vessel as shown in U.S. Pat. No. 4,954,756, the skilled person would not expect an increase in output power, as no mercury is present which can be mixed. Furthermore, in a previous section and in the experiments that have been performed, it is shown that the increase in output power of the mercury-free molecular discharge lamp according to the invention is not caused by a mixing effect, as the time needed to obtain the maximum output power is significantly longer compared to the time needed to reduce the increased output power to its original level. Therefore, the physical effect causing the increase of output power in the current invention must be different compared to that caused by the mixing of elements in the discharge. This is again emphasized by the fact that the orientation of the rotation axis of the discharge vessel does not need to be perpendicular to the electric field axis as required in U.S. Pat. No. 4,954,756. In a preferred embodiment of the current invention, the rotation axis of the discharge vessel is even substantially parallel to the electrical field to allow an elongated discharge vessel. Finally, U.S. Pat. No. 4,954,756 does not indicate that there is an optimum rotation speed which provides a significant increase in output power. U.S. Pat. No. 4,954,756 only indicates that the rotation speed must preferably be above a minimum rotation speed to ensure that the mixing of mercury is sufficient. In the mercury-free molecular discharge lamp according to the invention, a real optimum in the rotation speed is found, causing the output power to be reduced when the rotation speed is both higher and lower than the optimum rotation speed. Therefore, although a similar rotating discharge vessel may be used to obtain the increased output power in the mercury-free molecular discharge vessel according to the invention, the physics behind such effect are both different from what is known and unexpected in the light of the mixing principle shown in U.S. Pat. No. 4,954,756.

In an embodiment of the mercury-free molecular discharge lamp, the rotating means are configured for rotating the discharge vessel at a rotation-frequency, the rotation-frequency being below 20 Hertz.

In an embodiment of the mercury-free molecular discharge lamp comprising rotating means as the discharge-variation means, the discharge-variation means are configured for generating a varying electric and/or magnetic field for rotating and/or varying the discharge within the gas filling. An advantage of this embodiment is that this rotating and/or varying of the discharge and/or of the gas filling may be obtained without actually moving hardware to move the gas filling and/or discharge relative to each other. Moving and/or rotating hardware is subject to wear and requires maintenance and/or replacement to ensure a properly working mercury-free molecular discharge lamp. Such maintenance and/or replacement are relatively costly and should be avoided. By altering an electric and/or magnetic field near the discharge, the discharge may be moved and/or rotated within the gas filling without actually moving parts in the discharge vessel. Therefore, the life-time of the mercury-free molecular discharge lamp is improved and/or the maintenance costs are substantially reduced. Last but not least, the complexity of the discharge vessel is considerably reduced by avoiding the use of moving parts in the discharge vessel for moving the discharge relative to the gas filling.

In an embodiment of the mercury-free molecular discharge lamp, a rotation axis around which the rotating means rotate the discharge relative to the gas filling is substantially parallel to the electrical field for generating the discharge. A benefit of this embodiment is that also elongated discharge vessels may be used to contain the mercury-free molecular discharge vessel. Therefore, the light source may stretch over a certain distance rather than being substantially ball-shaped. Substantially parallel to the electrical field means in this context that the rotation axis of the rotating means may form a small angle with the direction of the electrical field, typically an angle smaller than or equal to 10 degrees.

In an embodiment of the mercury-free molecular discharge lamp, the gas filling comprises oxides and/or sulfides of group IIIB, IVB, VB and/or group VIB elements of the periodic table of elements. A benefit of this embodiment is that from the experiments the inventors have seen that these radiators are relatively sensitive to the invented varying of the dimension and/or position of the discharge relative to the gas filling, for example, in that they exhibit a relatively high gain in efficiency and/or efficacy.

In an embodiment of the mercury-free molecular discharge lamp, the oxides of group IIIB, IVB, VB and/or group VIB elements of the periodic table of elements comprise mono-oxides of group IIIB, IVB, VB and/or group VIB elements of the periodic table of elements. An advantage of this embodiment is that given the spectrum of the mono-oxides and stability of these di-atomic molecules, the improvement in efficacy is mainly due to their significant contribution to direct visible light emission.

In an embodiment of the mercury-free molecular discharge lamp, the mercury-free molecular discharge lamp is an electrodeless discharge lamp. The discharge means may, for example, comprise elements which maintain the discharge via inductive operation, or via capacitive operation, or via microwave operation. A benefit of electrodeless mercury-free molecular discharge lamps is that they provide more design freedom in respect of the filling of the discharge vessel. Especially when using molecular discharge lamps, the filling for these molecular discharge lamps often comprises halogen, which may damage the electrodes of the discharge lamp. Alternatively, a constituent of the gas filling may react with the electrodes in the discharge vessel and therefore alter the composition of the gas filling. This may result in a different color of the emitted light, or even in extinction of the discharge. Therefore, the use of an electrodeless mercury-free molecular discharge lamp provides larger design freedom as regards the choice of the gas filling for the mercury-free molecular discharge lamp.

A further advantage when using electrodeless mercury-free molecular discharge lamps is that the average lifetime of the electrodeless mercury-free molecular discharge lamp is considerably longer compared to conventional low-pressure gas discharge lamps which have electrical contacts through the discharge vessel to transfer power into the discharge space. Generally, the electrical contacts, also referred to as electrodes, limit the lifespan of conventional low-pressure gas discharge lamps. The electrodes may, for example, become contaminated with residue or, for example, get damaged by the discharge and cannot transfer sufficient power into the discharge space to guarantee operation of the conventional low-pressure gas discharge lamp.

In an embodiment of the mercury-free molecular discharge lamp, the mercury-free discharge lamp comprises tuning means for tuning the discharge-variation means for optimizing the output of the discharge lamp. This tuning means may tune the variation-frequency and variation-speed of the discharge relative to the gas filling to optimize the output power of the mercury-free molecular discharge lamp.

In an embodiment of the mercury-free molecular discharge lamp, the mercury-free molecular discharge lamp comprises a luminescent material. The luminescent material may, for example, be used to correct or fine-tune the color emitted by the mercury-free molecular discharge lamp by absorbing part of the light emitted from the discharge and converts the absorbed light into light of a different color. When the mercury-free molecular discharge lamp according to the invention is used for general illumination purposes, the mercury-free molecular discharge lamp preferably produces a predefined color of light. The luminescent layer comprising the luminescent material may be applied to an inner wall of the discharge vessel or to an outer wall of the discharge vessel. Applying the luminescent layer to the outer wall of the discharge vessel prevents the luminescent material from reacting with the gas filling inside the discharge vessel.

The invention also relates to an illumination system comprising the mercury-free molecular discharge lamp according to the invention. The illumination system may, for example, be a general illumination system for office illumination, street lamps, shop lighting and illumination systems for illuminating, for example, buildings. The illumination system may also be applied as, for example, automotive lighting.

### BRIEF DESCRIPTION OF THE DRAWINGS

These and other aspects of the invention are apparent from and will be elucidated with reference to the embodiments described hereinafter.

In the drawings:

FIG. 1 shows a cross-sectional view of a mercury-free molecular discharge lamp comprising electrodes according to the invention,

FIG. 2 shows a cross-sectional view of a mercury-free molecular discharge lamp comprising an inductive discharge means according to the invention,

FIGS. 3A and 3B show a cross-sectional view of a mercury-free molecular discharge lamp comprising a microwave discharge means according to the invention,

FIGS. 4A to 4D show different emission spectra of the mercury-free molecular discharge lamp according to the invention, and

FIG. 5 shows the output power of the mercury-free molecular discharge lamp according to the invention with respect to time, in which different rotation-frequencies are used for generating an emission spectrum of the low-pressure zirconium tetra-chloride gas discharge lamp.

The Figures are purely diagrammatic and not drawn to scale. Particularly for clarity, some dimensions are exaggerated strongly. Similar components in the Figures are denoted by the same reference numerals as much as possible.

### DETAILED DESCRIPTION OF THE PREFERRED EMBODIMENTS

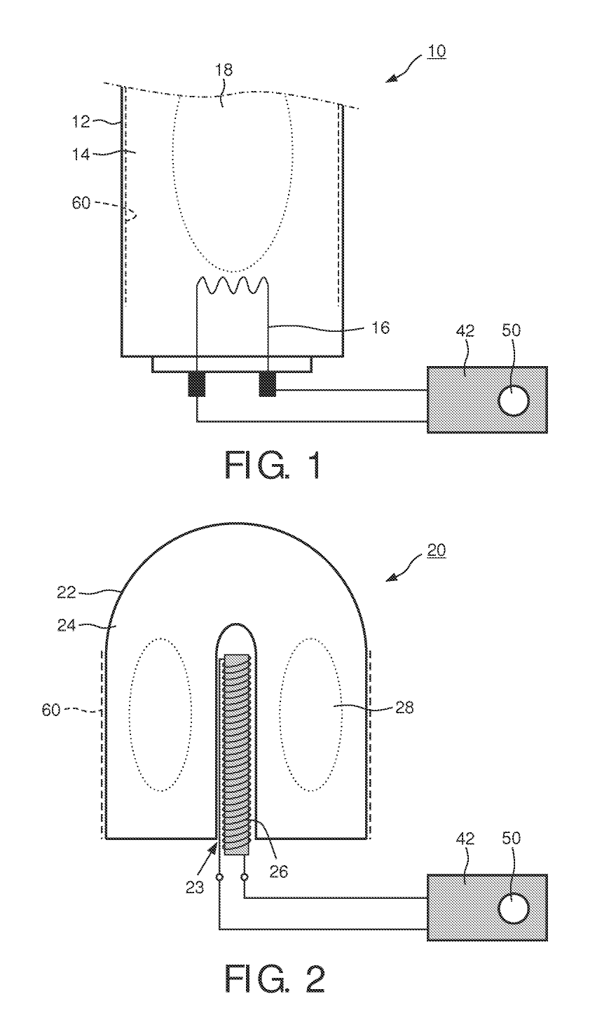

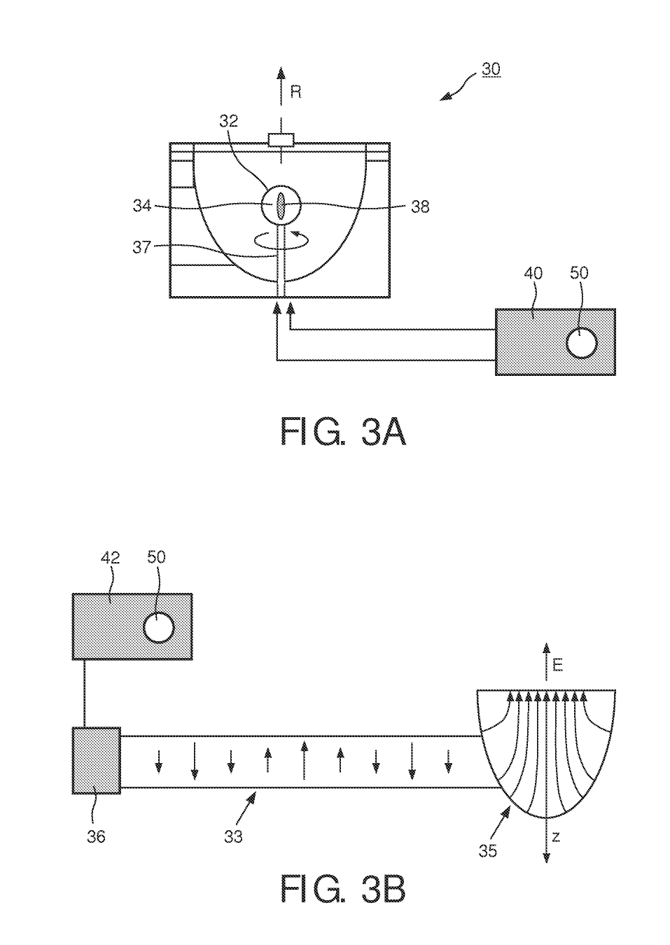

FIG. 1 shows a cross-sectional view of a mercury-free molecular discharge lamp 10 comprising electrodes 16 according to the invention. The mercury-free molecular discharge lamp 10 according to the invention comprises a light transmitting discharge vessel 12, having a wall which encloses a discharge space in a gas-tight manner. The discharge space comprises a gas filling 14, for example, comprising a metal compound of the group IIIB, IVB, VB and/or group VIB elements of the periodic table of elements. The mercury-free molecular discharge lamp 10 further comprises discharge means 16 which couple energy into the discharge space. The discharge means 16 may couple energy into the discharge space via capacitive coupling, inductive coupling (see FIG. 2), microwave coupling (see FIG. 3), or via electrodes 16 as shown in the example of FIG. 1, to obtain a gas discharge in the discharge space.

In the embodiment shown in FIG. 1, the discharge means 16 are a set of electrodes 16. In FIG. 1 only one electrode 16 of the set of electrodes 16 is shown. The electrodes 16 are electrical connections extending through the wall of the discharge vessel 12 of the mercury-free molecular discharge lamp 10. By applying an electrical potential difference between the two electrodes 16, a discharge 18 is generated and/or maintained between the two electrodes 16.

In general, light generation in the mercury-free molecular discharge lamp 10 is based on the principle that charge carriers, particularly electrons but also ions, are accelerated by an electric field applied between the electrodes 16 of the mercury-free molecular discharge lamp 10. Collisions of these accelerated electrons and ions with the gas atoms or molecules in the gas filling of the mercury-free molecular discharge lamp 10 cause these gas atoms or (preferably) molecules to be dissociated, excited or ionized. When the atoms or molecules of the gas filling return to the ground state, a more or less substantial part of the excitation energy is converted to radiation.

In the embodiment of the mercury-free molecular discharge lamp 10 shown in FIG. 1, the mercury-free molecular discharge lamp further comprises discharge-variation means 40, 42 which are configured for varying, in operation, the position of the discharge 18 within the gas filling 14 relative to each other, and/or for varying a dimension of the discharge 18 within the gas filling 14 over time to increase the output power of the mercury-free molecular discharge lamp 10. This discharge-variation means may be, for example, a modified power supply 42 which provides the power to the mercury-free molecular discharge lamp. This modified power supply 42 may, for example, generate a power signal being a pulsed signal, or, for example, a power signal in which an additional amplitude modulation is added to the power signal for varying the position and/or dimension of the discharge 18 relative to the gas filling 14. Alternatively, the modified power supply 42 may, for example, generate the power signal which further comprises an additional frequency modulation added to the power signal for varying the position and/or dimension of the discharge 18 relative to the gas filling 14. Such embodiments may alter the position and/or dimension of the discharge 18 relative to the gas filling at a predefined variation-frequency and/or variation-speed, such that the output power of the mercury-free molecular discharge is significantly improved. Significant improvement means an improvement, for example, up to a factor of two.

The embodiment shown in FIG. 1 further comprises a tuning means 50. This tuning means 50 may be used to further optimize the output power of the mercury-free molecular discharge lamp. Still, the tuning means 50 is optional. The optimum variation-frequency and/or variation-speed for a specific gas filling may be determined in a laboratory and the modified power supply 42 may be configured to operate at the predefined optimum variation-frequency and/or variation-speed without the need for optimization.

In the embodiment of the mercury-free molecular discharge lamp 10 shown in FIG. 1, a luminescent layer 60 is present at the inside of the discharge vessel 12. The luminescent layer 60, for example, absorbs part of the light emitted from the discharge 18 and converts the absorbed light into light of a different color. By choosing a specific luminescent material or mixture of luminescent materials, the color of the mercury-free molecular discharge lamp 10 can be determined due to the mixing of the visible light emitted from the discharge space 14 with the light emitted by the luminescent layer 60.

FIG. 2 shows a cross-sectional view of a mercury-free molecular discharge lamp 20 comprising the discharge means 26 constituted of an inductive coupler 26. The inductive coupler 26 may also be used for generating the discharge. The inductive coupler 26 generally comprises a coil wound over a ferrite core, for example Nickel-Zinc ferrite or Manganese-Zinc ferrite. The inductive coupler 26 is arranged in a protrusion 23 in the discharge vessel 22 and generates a varying electromagnetic field inside the discharge vessel 22 at the discharge space. Electrons and ions in the gas filling 24 of the discharge space are accelerated by the electromagnetic field and collide with other compounds in the gas filling, for example, molecular compounds. Due to the collision the molecular compounds are excited and subsequently emit light. The benefits of inductively generating and/or maintaining the discharge in the mercury-free molecular discharge lamp 20 is that the electrodes 16 (see FIG. 1), which generally limit the lifetime of discharge lamps, can be omitted. Alternatively, the inductive coupler 26 may be arranged external to (not shown) the discharge vessel 22, which results in a simplification of the manufacturing process for the discharge vessel 22. Also in the embodiment shown in FIG. 2, a luminescent layer 60 is applied, however, this luminescent layer 60 is applied to the outside of the discharge vessel 22.

Also in the embodiment of the mercury-free molecular discharge lamp 20 as shown in FIG. 2, the discharge-variation means 40, 42 are present, again embodied as modified power supply 42 which provides the power to the mercury-free molecular discharge lamp. This modified power supply 42 may generate a power signal being a pulsed power signal, a frequency modulated power signal and/or an amplitude modulated power signal for varying the position and/or dimension of the discharge 28 relative to the gas filling 24. Furthermore, the optional tuning means 50 may be present.

FIGS. 3A and 3B show a cross-sectional view of a third embodiment of the mercury-free molecular discharge lamp 30 according to the invention, in which the mercury-free molecular discharge lamp 30 comprises a microwave discharge means 36 connected to a waveguide 33 and to a microwave resonator 35 in which the discharge vessel 32 is located. The discharge vessel 32 consists, in the current embodiment, of a spherical quartz discharge vessel 32 mounted on a movable stand 37. The movable stand 37 is connected to the discharge variation means 40 which may, for example, be a rotating means 40 for rotating the discharge vessel 32 at a specific rotation frequency. Alternatively, the discharge variation means 42 may be a modified power supply 42 (see FIG. 3B) which may generate a microwave power signal being a pulsed microwave power signal, a frequency modulated microwave power signal and/or an amplitude modulated microwave power signal for varying the position and/or dimension of the discharge 38 relative to the gas filling 34 inside the discharge vessel 32. In both embodiments of the discharge-variation means 40, 42, optionally a tuning means 50 may be present.

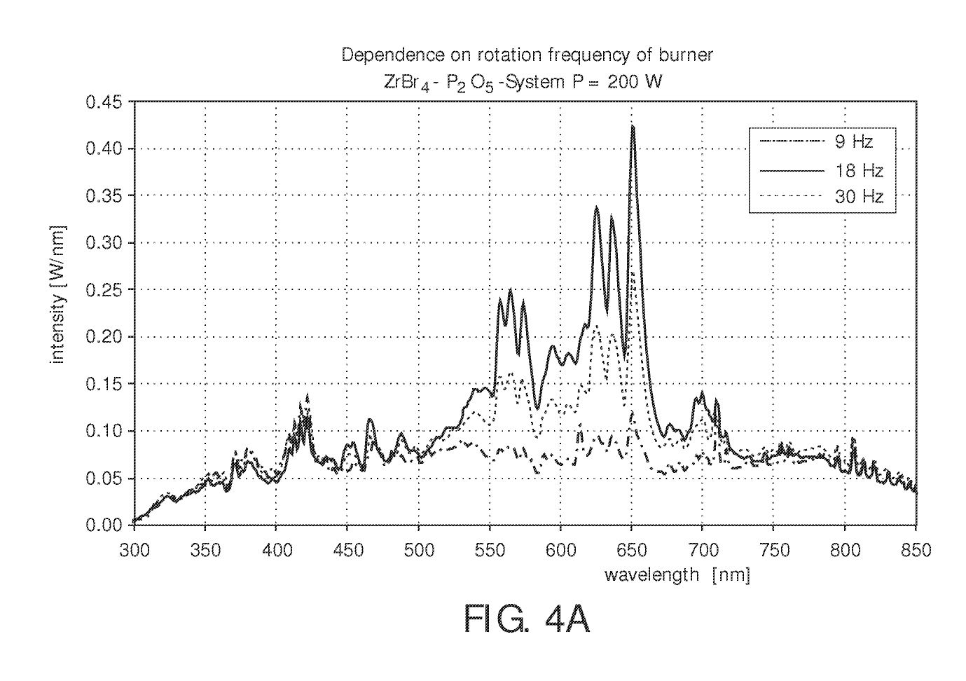

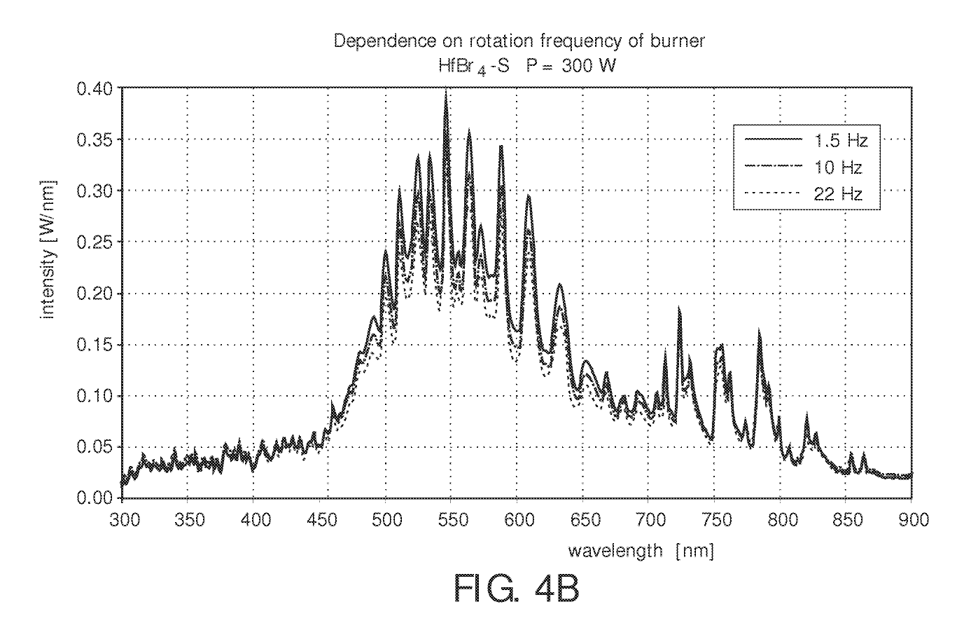

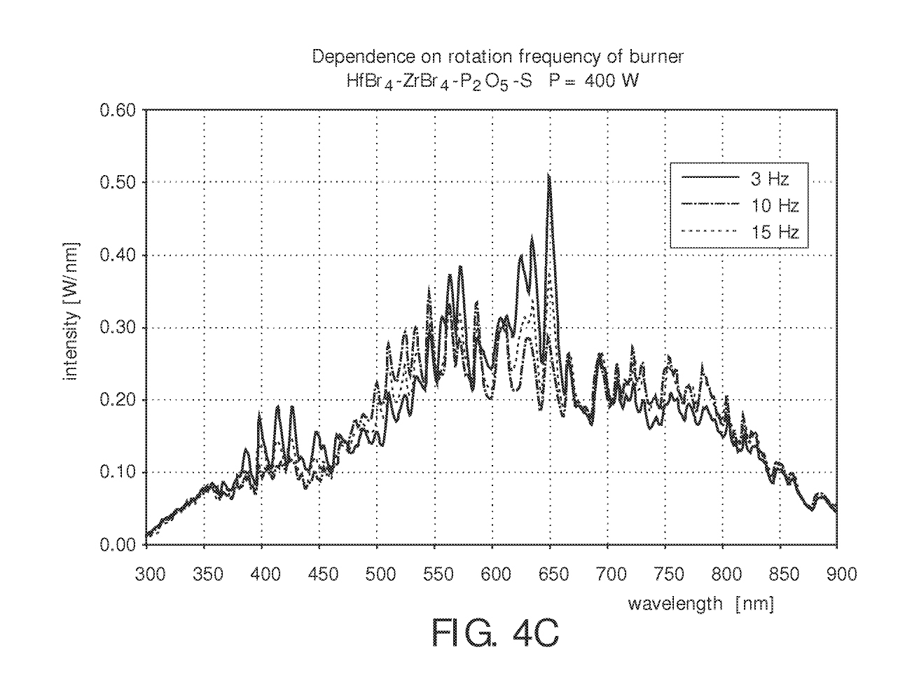

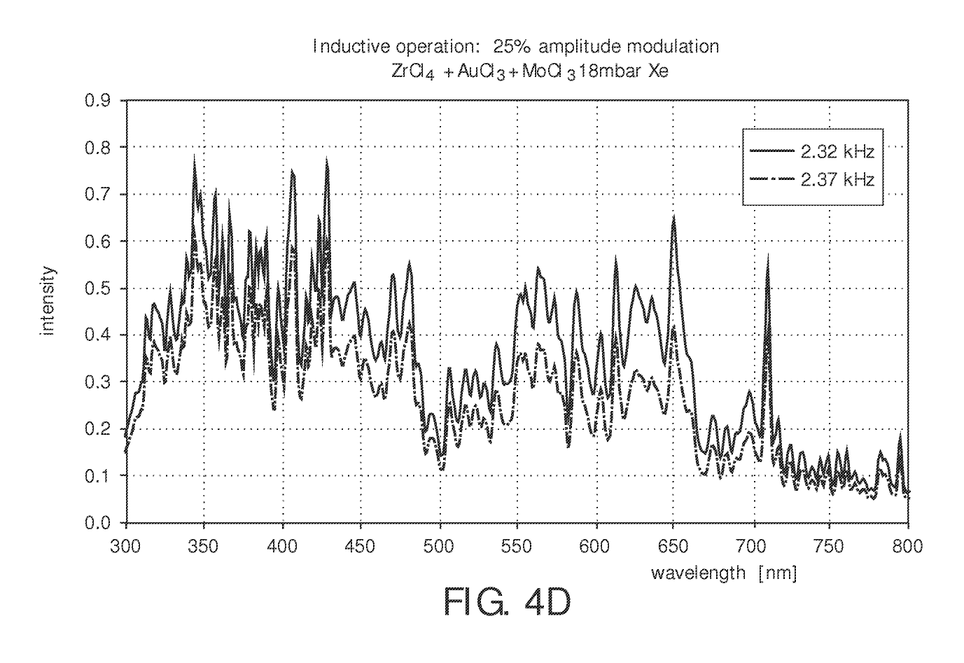

FIGS. 4A to 4D show different emission spectra of the mercury-free molecular discharge lamp according to the invention. The different emission spectra shown in FIGS. 4A to 4D show the improved emission characteristics due to the varying, in operation, of the position of the discharge 18, 28, 38 within the gas filling 14, 24, 34 relative to each other, and/or due to the varying of the dimension of the discharge 18, 28, 38 within the gas filling 14, 24, 34 over time for increasing the output power of the mercury-free molecular discharge lamp 10, 20, 30. The discharge vessels 12, 22, 32 which were used for measuring the spectra of FIGS. 4A to 4D are similar to those of the mercury-free molecular discharge lamp 30 as shown in FIGS. 3A and 3B.

FIG. 4A shows the emission spectrum of a first embodiment in which a spherical quartz discharge vessel 32 of 32.5 millimeter inner diameter, i.e. a volume of 18 cubic-centimeters, was filled with 1.32 milligram ZrBr₄, 0.23 milligram P₂O₅ and 100 millibar Ar (=filling pressure at room temperature). Such a lamp is further also indicated as ZrPH2-lamp. This ZrPH2 mercury-free molecular discharge lamp 30 was operated in a microwave resonator 35, as shown in FIGS. 3A and 3B, that was driven by an RF-field at 2.45 GHz. The discharge vessel 32 was rotated in the microwave resonator 35 at a rotation frequency •ᵣₒₜ with the rotational axis R perpendicular to the electrical field vector E.

The emission spectra as shown in FIG. 4A are obtained at a lamp-power of 200 Watt, using a rotation frequency •ᵣₒₜ of 9 Hertz, 18 Hertz and 30 Hertz. At a rotation frequency •ᵣₒₜ of 9 Hertz nearly no ZrO emission is visible in the spectrum: plasma radiation due to ZrO-band emission mainly takes place in a wavelength range between λ=600 nanometer and 650 nanometer as well as λ=530 nanometer and 570 nanometer. Doubling the rotation frequency •ᵣₒₜ to 18 Hertz changes discharge emission significantly as the emission of molecular ZrO is strongly added to the overall emission spectrum of the mercury-free molecular discharge lamp 30. Further increasing the rotation frequency •ᵣₒₜ to 30 Hertz again decreases the contribution of molecular ZrO to the overall emission spectrum of the mercury-free molecular discharge lamp 30. This clearly indicates that there is an optimum rotation frequency •ᵣₒₜ at approximately 18 Hertz at which the emission efficiency of the ZrPH2-lamp is optimized.

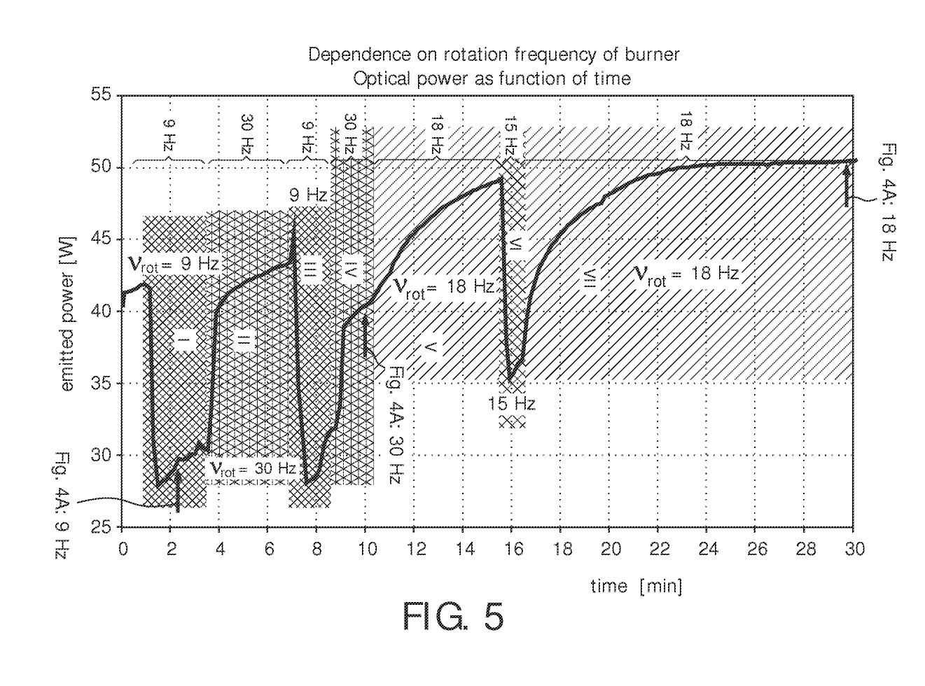

As already can be seen from FIG. 4A, specifically the optical power in the visible range (400 nanometer-800 nanometer) is significantly changed by varying the rotation frequency •ᵣₒₜ, which significantly improves the efficiency of the mercury-free molecular discharge lamp 30 for generating visible light. The gradual improvement of the output power of the mercury-free molecular discharge lamp 30 of FIG. 4A is shown also in FIG. 5, which shows that the overall output power due to the rotation frequency •ᵣₒₜ at 18 Hertz is almost doubled compared to the output power at a rotation frequency •ᵣₒₜ away from 18 Hertz.

FIG. 4B shows the emission spectrum of a second embodiment in which a spherical quartz discharge vessel 32 of 32.5 millimeter inner diameter, i.e. a volume of 18 cubic-centimeters, was filled with 1.17 milligram HfBr₄, 0.10 milligram of Sulfur and 100 millibar Ar (=filling pressure at room temperature). Such a lamp is further also indicated as HfSH4-lamp. This HfSH4 mercury-free molecular discharge lamp 30 was operated in a microwave resonator 35, as shown in FIGS. 3A and 3B, that was driven by an RF-field at 2.45 GHz. The discharge vessel 32 was rotated in the microwave resonator 35 at a rotation frequency •ᵣₒₜ, with the rotational axis R perpendicular to the electrical field vector E.

The emission spectra as shown in FIG. 4B are obtained at a lamp-power of 300 Watt, using a rotation frequency •ᵣₒₜ of 1.5 Hertz, 10 Hertz and 22 Hertz. Despite the results shown in the first embodiment shown in FIG. 4A, here an optimum optical power and maximum emission of the hafnium-mono-sulfide molecule is obtained at a low rotation frequency νᵣₒₜ of 1.5 Hertz. Increasing the rotation frequency νᵣₒₜ to 10 Hz and even 22 Hertz (slightly) decreases the optical power and the amount of hafnium-mono-sulfide emission. This clearly indicates that there is an optimum rotation frequency •ᵣₒₜ in this second embodiment having a different gas mixture, at approximately 1.5 Hertz at which the emission efficiency of the HfSH4-lamp is optimized.

FIG. 4C shows the emission spectrum of a third embodiment in which a spherical quartz discharge vessel 32 of 32.5 millimeter inner diameter, i.e. a volume of 18 cubic-centimeters, was filled with 0.92 milligram HfBr₄, 0.46 milligram ZrBr₄, 0.28 milligram of P₂O₅, and 0.13 milligram of Sulfur and 100 millibar Ar (=filling pressure at room temperature). Such a lamp is further also indicated as ZrHfH1-lamp. This ZrHfH1 mercury-free molecular discharge lamp 30 was operated in a microwave resonator 35, as shown in FIGS. 3A and 3B, that was driven by an RF-field at 2.45 GHz. The discharge vessel 32 was rotated in the microwave resonator 35 at a rotation frequency •ᵣₒₜ, with the rotational axis R perpendicular to the electrical field vector E.

The emission spectra as shown in FIG. 4C are obtained at a lamp-power of 400 Watt, using a rotation frequency •ᵣₒₜ of 3 Hertz, 10 Hertz and 15 Hertz. While nearly no influence on the optical power is visible, the emission characteristics (and therefore color temperature and color point) change significantly. At a low rotational frequency •ᵣₒₜ of 3 Hertz (black solid line in FIG. 4C), emission by ZrO is clearly visible on a broadband background signal (compare black solid line in FIG. 4A). By increasing the rotation frequency νᵣₒₜ to 10 Hertz (white solid line in FIG. 4C), the HfS emission increases on the broad background (compare with FIG. 4B in embodiment 2 for the spectrum), while light from ZrO molecules is suppressed. A further increase of the rotation frequency νᵣₒₜ to 15 Hz (black dashed line in FIG. 4C) leads to a mixture of ZrO and HfS emission on the background.

FIG. 4D shows the emission spectrum of a fourth embodiment in which a tubular quartz envelope of 48 millimeter inner diameter and 100 millimeter length, i.e. a volume of 180 cubic-centimeters, was filled with 0.19 milligram ZrCl₄, 0.55 milligram MoCl₃, 0.80 milligram AuCl₃ and 18 millibar Xe (=filling pressure at room temperature). Such a lamp is operated at 280 Watt of RF power of 14 Megahertz frequency which was inductively coupled into the lamp by means of an air coil (see FIG. 2) with 7 windings arranged on the outer surface of the quartz envelope. The supplied RF-power is generated by a signal-generator power-amplifier system 42, and two capacitors are used as matching network to match the lamp impedance to the output impedance of the amplifier (being 50Ω).

The output power into the matching network together with the matching output impedance was modulated by using the AM-mode of the signal generator (% amplitude modulation AM and modulation frequency ν_{mod}). At a coldest spot temperature of about 330 C., the emission spectra for two different modulation frequencies ν_{mod} at 25% Amplitude Modulation are plotted in FIG. 4D.

Around the modulation frequency ν_{mod} of approximately 2.3 kilohertz the discharge 28 (see FIG. 2) shows some plasma instabilities (small movement of the discharge along axis of the air coil). The velocity of the movement depends on the modulation frequency ν_{mod}. Small variations of the modulation frequency ν_{mod} result in significant changes of the emission spectrum (see FIG. 4D). At the lower modulation frequency ν_{mod} of 2.32 kilohertz (black solid line of FIG. 4D) the optical power is higher and molecular emission due to ZrO is improved compared to the higher modulation frequency ν_{mod} of 2.37 kilohertz (white solid line of FIG. 4D).

FIG. 5 shows an output power of the mercury-free molecular discharge lamp according to the invention with respect to time. The graph of FIG. 5 shows different rotation frequency transitions in time. As can be seen in FIG. 5, the transition to the optimum variation-speed—being 18 Hertz in the composition of the first embodiment of FIG. 4A,—causes the increase to the maximum output power to progress gradually and it may take more than 15 minutes to reach the maximum output power. After a transition away from the optimum variation-speed a reduction of the output power occurs much faster—within less than a minute. From this graph it can be concluded that the effect which generates the increased output power in each of the examples shown in FIGS. 4A to 4D is not caused by improved mixing due to the rotation of the discharge vessel 12, 22, 32, but has some other physical cause which is not fully understood at this moment.

In a first region, the rotation frequency •ᵣₒₜ of the discharge vessel 32 is 9 Hertz, which clearly is not an optimum rotation frequency for the first embodiment composition as shown in FIG. 4A. The emitted output power reduces gradually. The first spectrum of FIG. 4A, labeled 9 Hertz, is measured at the arrow indicated in the first region (indicated by a roman I). Subsequently, a second region (indicated by a roman II) comprises a rotation frequency •ᵣₒₜ of 30 Hertz. This second rotation frequency provides a slightly improved output power, however the time required to improve the output power is up to 5 minutes. Subsequently, in a third region (indicated by a roman III) of the graph shown in FIG. 5, the rotation frequency •ᵣₒₜ has again been changed to 9 Hertz and a quick output power reduction is observed. In a fourth region (indicated by a roman IV) of FIG. 5, a change back to the rotation frequency •ᵣₒₜ of 30 Hertz results in a time-behavior similar to that of the transition I-II (as expected). However, it would again take approximately 3 minutes for the intensity to regain the level of region II.

Subsequently, a fifth region (indicated by a roman V) comprises a rotation frequency •ᵣₒₜ of 18 Hertz. This seems to be the optimum rotation frequency •ᵣₒₜ with respect to discharge efficiency. After 5 minutes of rotation of the discharge vessel at the rotation frequency •ᵣₒₜ of 18 Hertz, the intensity has increased gradually while no other parameter of the mercury-free molecular discharge lamp has altered. A short change of frequency to a rotation frequency •ᵣₒₜ of 15 Hertz in the sixth region (indicated by a roman VI) causes the output power to quickly decrease. Within the data sampling rate for this scan (1 data point per 10 s) the intensity drops to about 70% of the original value. After less than a minute the rotation frequency was reset to the rotation frequency •ᵣₒₜ of 18 Hertz in the seventh region (indicated by a roman VII). Now it still takes about 15 min until the maximum intensity at high efficiency has been reached.

Therefore, in order to find the optimum frequency for the mercury-free molecular discharge lamp according to the invention, the following steps may be executed:

the variation-frequency and/or variation-speed are increased, and

when the output power gradually increases, a further increase of the variation-frequency and/or variation-speed is realized,

when the output power decreases relatively abruptly, a reduction of the variation-frequency and/or variation-speed is realized to a previous variation frequency and/or variation-speed at which the output power was still increasing.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements. In the device claim enumerating several means, several of these means may be embodied by one and the same item of hardware. The mere fact that certain measures are recited in mutually different dependent claims does not indicate that a combination of these measures cannot be used to advantage.

1. A mercury-free molecular discharge lamp (10, 20, 30), comprising:
a light-transmitting discharge vessel (12, 22, 32) enclosing, in a gastight manner, a discharge space comprising a gas filling (14, 24, 34),
discharge means (16, 26, 36) for maintaining a discharge (18, 28, 38) in the discharge space, and
discharge-variation means (40, 42) for varying, in operation, the position of the discharge (18, 28, 38) within the gas filling (14, 24, 34) relative to each other, and/or for varying a dimension of the discharge (18, 28, 38) within the gas filling (14, 24, 34) over time for increasing the output power and/or luminous flux of the mercury-free molecular discharge lamp (10, 20, 30).

2. Mercury-free molecular discharge lamp (10, 20, 30) as claimed in claim 1, wherein the discharge-variation means (40, 42) are configured for varying the position and/or dimension of the discharge (18, 28, 38) within the gas filling (14, 24, 34) continuously and/or periodically.

3. Mercury-free molecular discharge lamp (10, 20, 30) as claimed in claim 1, wherein the discharge-variation means (40, 42) are configured for varying the position and/or dimension at an optimum variation-speed and/or optimum variation-frequency, the optimum variation-speed and/or the optimum variation-frequency depending on the gas filling (14, 24, 34) of the discharge space, and for generating an optimum output power of the mercury-free molecular discharge lamp (10, 20, 30).

4. Mercury-free molecular discharge lamp (10, 20, 30) as claimed in claim 1, wherein the discharge-variation means (40, 42) comprise:
rotating means (40) for rotating the discharge (18, 28, 38) and the gas filling (14, 24, 34) relative to each other for varying the position and/or dimension of the discharge (18, 28, 38), and/or
pulse-generation means (42) for applying a power to the mercury-free molecular discharge lamp (10, 20, 30) in a pulsed-mode for varying the position and/or dimension of the discharge (18, 28, 38), and/or
amplitude-modulation means (42) for applying power to the mercury-free molecular discharge lamp (10, 20, 30) in an amplitude-modulation mode for varying the position and/or dimension of the discharge (18, 28, 38), and/or
frequency-modulation means (42) for applying power to the mercury-free molecular discharge lamp (10, 20, 30) in a frequency-modulation mode for varying the position and/or dimension of the discharge (18, 28, 38).

5. Mercury-free molecular discharge lamp (10, 20, 30) as claimed claim 1, comprising rotating means (40) as the discharge-variation means (40, 42), wherein the rotating means (40) are configured for rotating the discharge vessel (12, 22, 32).

6. Mercury-free molecular discharge lamp (10, 20, 30) as claimed in claim 5, wherein the rotating means (40) are configured for rotating the discharge vessel (12, 22, 32) at a rotation-frequency, the rotation-frequency being below 20 Hertz.

7. Mercury-free molecular discharge lamp (10, 20, 30) as claimed in claim 1, wherein the discharge-variation means (40, 42) are configured for generating a varying electric and/or magnetic field for rotating and/or varying the discharge (18, 28, 38) within the gas filling (14, 24, 34).

8. Mercury-free molecular discharge lamp (10, 20, 30) as claimed in claim 4, wherein a rotation axis (R) around which the rotating means (40) rotate the discharge (18, 28, 38) relative to the gas filling (14, 24, 34) is substantially parallel to the electrical field (E) for generating the discharge (18, 28, 38).

9. Mercury-free molecular discharge lamp (10, 20, 30) as claimed in claim 1, wherein the gas filling comprises oxides and/or sulfides of group IIIB, IVB, VB and/or group VIB elements of the periodic table of elements.

10. Mercury-free molecular discharge lamp as claimed in claim 9, wherein the oxides of group IIIB, IVB, VB and/or group VIB elements of the periodic table of elements comprise mono-oxides of group IIIB, IVB, VB and/or group VIB elements of the periodic table of elements.

11. Mercury-free molecular discharge lamp (10, 20, 30) as claimed in claim 1, wherein the mercury-free molecular discharge lamp (10, 20, 30) is an electrodeless discharge lamp (10, 20, 30).

12. Mercury-free molecular discharge lamp (10, 20, 30) as claimed in claim 1, wherein the mercury-free discharge lamp (10, 20, 30) comprises tuning means (50) for tuning the discharge-variation means (40, 42) for optimizing the output of the discharge lamp (10, 20, 30).

13. Mercury-free molecular discharge lamp (10, 20, 30) as claimed in claim 1, wherein the mercury-free molecular discharge lamp (10, 20, 30) comprises a luminescent material (60).

14. An illumination system comprising the mercury-free molecular discharge lamp (10, 20, 30) according to claim 1.
